(19) United States
(12) Patent Application Publication
(10) Pub. No.: US 2009/0168300 A1
(43) Pub. Date: Jul. 2, 2009

(54) High-voltage capacitor

(76) Inventors: Siegfried Birkle, Höchstadt (DE); Stefan Hain, Effeltrich (DE); Norbert Koch, Köln (DE); Guenter Trojan, Troisdorf (DE)

Correspondence Address: STAAS & HALSEY LLP, SUITE 700, 1201 NEW YORK AVENUE, N.W., WASHINGTON, DC, 20005, US

(21) Appl. No.: 11/661,390

(22) PCT Filed: Aug. 9, 2005
(86) PCT No.: PCT/EP2005/053915

§ 371 Date: Nov. 3, 2008

(30) Foreign Application Priority Data
Aug. 30, 2004 (DE) 10 2004 042 307.5

(51) Int. Cl. H01G 4/38

(52) U.S. Cl. 361/328

(57) ABSTRACT

A high-voltage capacitor is used to transmit energy and has an insulator housing, wherein at least two serially connected capacitors, which are mounted in parallel, are arranged. Said capacitors are made of, respectively, a serial connection of individual capacitors which are embodied as stackable capacitor elements. The resulting high-voltage capacitor is compact and economical. Each capacitor element comprises several individual capacitors which are maintained in an isolated manner, whereby the number corresponds to the number of serially connected capacitors, such that said serially connected capacitors are formed by one stack of capacitor elements.

### CROSS REFERENCE TO RELATED APPLICATIONS

This application is based on and hereby claims priority to application No. PCT/EP2005/053915 filed on Aug. 9, 2005 and DE Application No. 10 2004 042 307.5 filed Aug. 30, 2004, the contents of which are hereby incorporated by reference.

### BACKGROUND

The invention relates to a high-voltage capacitor for power distribution.

High-voltage capacitors for power distribution are known, for example, from DE 28 47 775 A1. The high-voltage capacitor disclosed there has a cylindrical or prismatic insulator housing, in which a capacitor series circuit is arranged. The capacitor series circuit comprises capacitor elements whose individual capacitors are connected to one another in series via connecting pieces. In this case, the capacitor elements have flat windings of metal strips, which are used as electrode surfaces of the individual capacitors. The metal strips are separated from one another by a dielectric or insulating layer, with the insulating layer being composed of a plurality of dielectric films. The capacitor series circuit is arranged in a frame, which ensures that the capacitor series circuit is held mechanically.

DE 195 10 624 C1 describes a wound capacitor in which a plurality of individual capacitors are fitted to a winding of a dielectric film.

By way of example, in the field of power distribution, high-voltage capacitors are used as voltage dividers, energy stores, filter components or the like. For redundancy reasons, in order to increase the capacity or for parallel measurement, it has become normal in many cases in power distribution to connect high-voltage capacitors in parallel.

It is thus known for two capacitor series circuits each having an insulator housing to be integrated electrically in parallel in power distribution installations. Since the useful life of the insulator housings, which are designed to be weather-resistant, is subject to stringent requirements in order to achieve the required overall life, these housings contribute considerably to the costs of a high-voltage capacitor such as this. A high-voltage capacitor such as this is therefore costly.

It is also known for two capacitor series circuits, which are connected in parallel to be accommodated in one insulator housing—for example a hollow-cylindrical porcelain housing. In this case, as normal, the capacitor series circuits comprise individual capacitors which are connected in series with one another and are in the form of stackable capacitor elements. A frame composed of insulating material is provided in order to hold the stacked capacitor elements and, in addition, it is also designed to press the capacitor elements against one another. The capacitor elements which have been pressed against one another in the holder or the frame form the capacitor series circuit and are also referred to as the active part. Active parts such as these are normally in the form of boxes or are cubic and are known to be fitted alongside one another in the insulator housing. However, when two cubic active parts are placed alongside one another in a hollow-cylindrical insulator housing, this leads to a space-consuming high-voltage capacitor. In addition, the assembly of two active parts is linked to high production and assembly costs. A further disadvantage is that it is generally impossible to produce exactly identical active parts, whose stack height may vary between one and several meters. Particularly in the case of relatively large active parts, voltage differences therefore occur between the active parts. However, voltage differences such as these are undesirable and can lead to limiting of the maximum voltage which may be dropped between the connecting terminals of the high-voltage capacitor.

### SUMMARY

One potential object of the present invention is therefore to provide a high-voltage capacitor which comprises parallel-connected capacitor series circuits for high-voltage applications, with the high-voltage capacitor being compact and costing little.

The inventors propose a high-voltage capacitor having an insulator housing in which at least two capacitor series circuits, which are connected in parallel with one another, are arranged and each comprise a series circuit of individual capacitors which are in the form of stackable capacitor elements with each capacitor element having a plurality of individual capacitors which are held such that they are isolated, and the number of which corresponds to the number of capacitor series circuits, such that the capacitor series circuits are formed by only one stack of the capacitor elements.

While, according to the related art, each capacitor element forms only one individual capacitor, each capacitor element provides a plurality of individual capacitors. In this case, the individual capacitors of a capacitor element are isolated from one another. In order to form the series circuit, the individual capacitors of a capacitor element are each electrically connected to the individual capacitors of the adjacent capacitor element. Largely balanced series circuits are formed within a stack, so that voltage differences between the capacitor series circuits are avoided. The capacitor elements which are arranged in the form of stacks can be stored in a compact form and are surrounded by a single insulator housing. This results in a compact and low-cost high-voltage capacitor.

A capacitor element advantageously comprises a winding composed of an insulating film which is provided with electrically conductive coatings on both sides. In other words, the capacitor element is in the form of a known wound capacitor which has a dielectric in the form of a film, that is to say a wound dielectric. The dielectric is arranged between the conductive coatings, that is to say between the electrode surfaces or the individual capacitors. The conductive coatings of the individual capacitors are, for example, thin metal foils which are applied to the dielectric using any desired process. For example, the metal foils are vapor-deposited or adhesively bonded. The coated dielectric film is then wound to form a winding, with an insulating layer, which is additionally wound in, and is composed, for example, of oiled paper or of a further thin film material, prevents the conductive coatings from making contact in the winding. The insulating film expediently has a length of 1 to 5 meters, with the width of the insulating film being dependent on the number of desired capacitor series circuits. Two individual capacitors are advantageously provided on each capacitor element.

In a further development relating to this, the capacitor element is designed such that in the wound state, the conductive coatings on a first side of the insulating film rest bare on a first side of each capacitor element and in that the conductive coatings on a second side of the insulating film rest bare on a second side of each capacitor element, opposite the first side. In other words, the electrodes with the higher potential on the individual capacitors that occurs during operation rest, for example, bare on the upper face of the capacitor element, while the other electrode, to which a lower potential is applied during operation, rests bare on the lower face of the capacitor element. This allows a series circuit of the individual capacitors to be formed simply by stacking of the capacitor elements. There is no need for contact to be made in a complex form.

The capacitor series circuits expediently have a holding unit composed of an insulating material. The holding unit is used to hold the capacitor elements that have been stacked one on top of the other. If the capacitor elements are in the form of a winding, it is advantageous to press the winding flat, or to wind the coated film on a flat winding former from the start. The insulating material of the holding unit is, for example, a plastic, a ceramic or the like. In a further development relating to this, the capacitor elements are pressed against one another by the holding unit.

The capacitor series circuits are advantageously arranged in a dielectric material, with which the housing is filled. Synthetic oil or resin is normally used as the dielectric material, with the resin being inserted in the liquid state into the insulator housing in which the capacitor series circuits are arranged. The resin is then cured.

The insulator housing is advantageously composed of a ceramic or a composite material. For example, the ceramic is porcelain. Plastics reinforced with glass fibers are normally used as a composite material. Substance or material compositions which differ from this are, of course, also possible for the proposed capacitor.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 shows one exemplary embodiment of a capacitor element according to one embodiment of the invention, in the form of a perspective view,

FIG. 2 shows one exemplary embodiment of a capacitor series circuit according to one embodiment of the invention, in the form of a perspective view, and

FIG. 3 shows one exemplary embodiment of a high-voltage capacitor according to one embodiment of the invention, in the form of a plan view.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

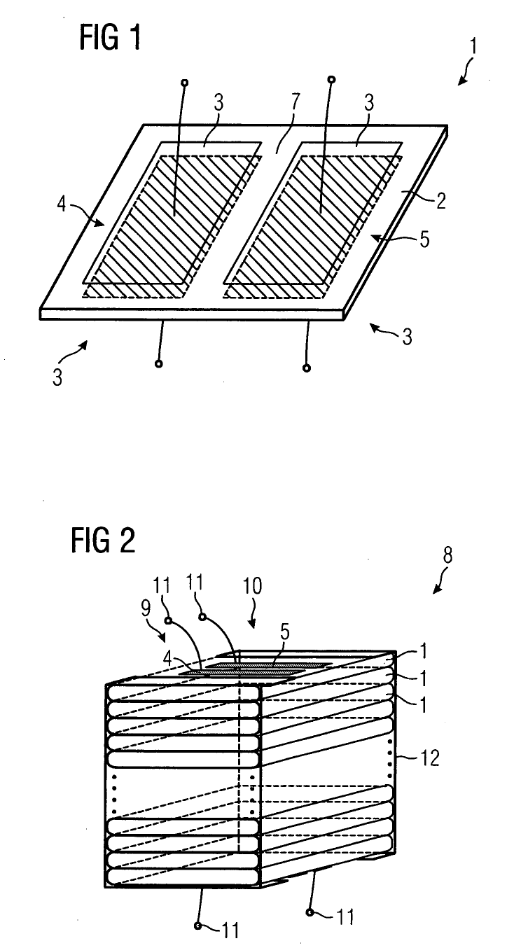

FIG. 1 shows one exemplary embodiment of a capacitor element 1, before it is wound. The illustrated capacitor element 1 comprises an insulating or dielectric film 2, to both sides of which thin metal foils 3 are fitted as electrically conductive coatings. In this case, a total of four metal foils 3 can be seen, two of which are in each case located opposite one another in pairs on different sides of the insulating film 2, and in this way form a first individual capacitor 4 and a second individual capacitor 5. The individual capacitors 4 and 5 are isolated from one another by an insulating rod 7, which runs between the individual capacitors 4 and 5. The individual capacitors 4 and 5 can be formed largely symmetrically with respect to one another by two individual capacitors being fitted on one insulating or dielectric film 2.

FIG. 2 shows an exemplary embodiment of an active part 8 which comprises capacitor elements 1 arranged stacked one above the other. The capacitor elements 1 are in the form of flat windings, whose flat faces in the stack, or in other words in the active part 8, rest on one another. In this case, the first individual capacitors 4 and the second individual capacitors 5 of the capacitor elements 1 are connected in series with one another, thus forming a first series capacitor circuit 9 and a second series capacitor circuit 10. The uppermost capacitor element 1 and the lowest capacitor element 1 in the active part 8 shown in FIG. 2 are each provided with connecting terminals 11.

A supporting frame 12, which is composed of a dielectric material, is provided in order to press the capacitor elements 1 against one another, and to hold them.

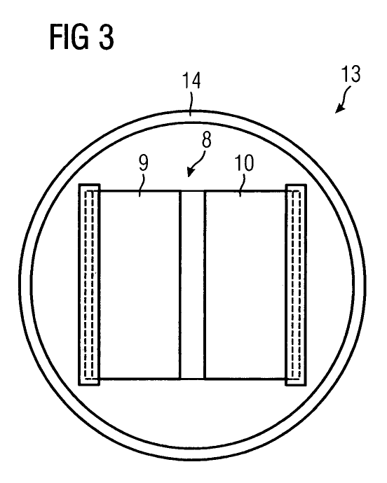

FIG. 3 shows one exemplary embodiment of the high-voltage capacitor 13, in the form of a plan view. As can be seen, the active part 8 which is shown in FIG. 2 is arranged in an insulator housing 14. The insulator housing 14 is manufactured from porcelain, and has outer ribs, which are not illustrated in FIG. 3, in order to increase the creepage distance of the high-voltage capacitor 13. The insulator housing 14 is also filled with a synthetic oil, thus providing the required dielectric strength for voltages in the region of 100 KV.

The connecting terminals, which are not illustrated in FIG. 3, of each capacitor series circuit are passed out of the cylindrical insulator housing on mutually opposite end faces of the latter. In this case, the insulator housing is sealed. This results in a high-voltage capacitor 13 which is weather-resistant over relatively long time periods.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A high-voltage capacitor, comprising:
an insulator housing;
at least two capacitor series circuits provided in the insulator housing, the capacitor series circuits being connected in parallel with one another, each capacitor series circuit being formed from a series of individual capacitor elements, the individual capacitor elements being stacked in a stack, each layer of the stack having a plurality of individual capacitor elements which are held in isolation from one another, the number of individual capacitor elements per layer corresponding to the number of capacitor series circuits, such that the capacitor series circuits are formed by only one stack of the capacitor elements.

9. The high-voltage capacitor as claimed in claim 8, wherein each capacitor element is formed from a winding of electrically insulating film which is provided with an electrically conductive coating on each side thereof.

10. The high-voltage capacitor as claimed in claim 9, wherein, for each capacitor element in a wound state, a first conductive coating rests bare on a first side of the insulating film and a second conductive coating rests bare on a second side of the insulating film, opposite the first side.

11. The high-voltage capacitor claim 8,
wherein the stack of individual capacitor elements is held by an insulating holding unit.

12. The high-voltage capacitor claim 8, wherein
the capacitor series circuits are provided in a dielectric material, and
the dielectric material is provided in the insulator housing such that the insulator housing holds the dielectric material around the capacitor series circuits.

13. The high-voltage capacitor as claimed in claim 12, wherein the dielectric material is an oil.

14. The high-voltage capacitor as claimed in claim 8, wherein the insulator housing is formed of a ceramic or composite material.

15. The high-voltage capacitor claim 10,
wherein the stack of individual capacitor elements is held by an insulating holding unit.

16. The high-voltage capacitor claim 15, wherein
the capacitor series circuits are provided in a dielectric material, and
the dielectric material is provided in the insulator housing such that the insulator housing holds the dielectric material around the capacitor series circuits.

17. The high-voltage capacitor as claimed in claim 16, wherein the dielectric material is an oil.

18. The high-voltage capacitor as claimed in claim 17, wherein the insulator housing is formed of a ceramic or composite material.

19. A high-voltage capacitor, comprising:
an insulator housing; and
at least two capacitor series circuits provided in the insulator housing, the capacitor series circuits being connected in parallel with one another, wherein
each capacitor series circuit is formed from a series of individual capacitor elements,
the individual capacitor elements are stacked in a stack,
each layer of the stack has one capacitor element from each capacitor series circuit such that the number of individual capacitor elements per layer is equal to the number of capacitor series circuits,
within each layer, the individual capacitor elements are held in isolation from one another, and
the capacitor series circuits are all formed from only one stack of the capacitor elements.
